(19) United States
(12) Patent Application Publication
(10) Pub. No.: US 2019/0162987 A1
(43) Pub. Date: May 30, 2019

(54) PHASE-SHIFTER FOR OPTICAL MODULATION

(71) Applicant: Rain Tree Photonics Pte. Ltd., Singapore (SG)

(72) Inventors: Ying Huang, Singapore (SG); Tsung-Yang Liow, Singapore (SG)

(73) Assignee: Rain Tree Photonics Pte. Ltd., Singapore (SG)

(21) Appl. No.: 16/206,133

(22) Filed: Nov. 30, 2018

Related U.S. Application Data
(60) Provisional application No. 62/592,427, filed on Nov. 30, 2017.

(51) Int. Cl. G02F 1/025

(52) U.S. Cl. CPC G02F 1/025; G02F 2203/50

(57) ABSTRACT

A phase-shifter (10) for optical modulation is provided. The phase-shifter (10) includes a first electrode (12), a second electrode (14), a waveguide (16) in a folded configuration between the first and second electrodes (12, 14), and one or more PN junctions (18, 20) provided with the waveguide (16) and connected to the first and second electrodes (12, 14).

### FIELD OF THE INVENTION

The present invention relates to the field of photonics and more particularly to a phase-shifter for optical modulation.

### BACKGROUND OF THE INVENTION

Electro-optic phase shifters with embedded PN junctions within optical waveguides are used in high speed applications. However, the electro-optical effect of such phase shifters is weak. It is therefore desirable to provide a phase-shifter with improved performance for high speed modulation.

### SUMMARY OF THE INVENTION

Accordingly, in a first aspect, the present invention provides a phase-shifter for optical modulation. The phase-shifter includes a first electrode, a second electrode, a waveguide in a folded configuration between the first and second electrodes, and one or more PN junctions provided with the waveguide and connected to the first and second electrodes.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1A is schematic top plan view of a phase-shifter for optical modulation in accordance with an embodiment of the present invention;

FIG. 1B is a schematic cross-sectional view of the phase-shifter taken along line A-A in FIG. 1A;

FIG. 1C is a schematic cross-sectional view of the phase-shifter taken along line B-B in FIG. 1A;

FIG. 2 is a schematic top plan view of a phase-shifter for optical modulation in accordance with another embodiment of the present invention;

FIG. 3 is a schematic top plan view of a phase-shifter for optical modulation in accordance with yet another embodiment of the present invention;

FIG. 4 is a schematic top plan view of a phase-shifter for optical modulation in accordance with still another embodiment of the present invention;

FIG. 5 is a schematic top plan view of a phase-shifter for optical modulation in accordance with yet another embodiment of the present invention; and

FIG. 6 is schematic top plan view of a phase-shifter for optical modulation in accordance with still another embodiment of the present invention.

### DETAILED DESCRIPTION OF EXEMPLARY EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

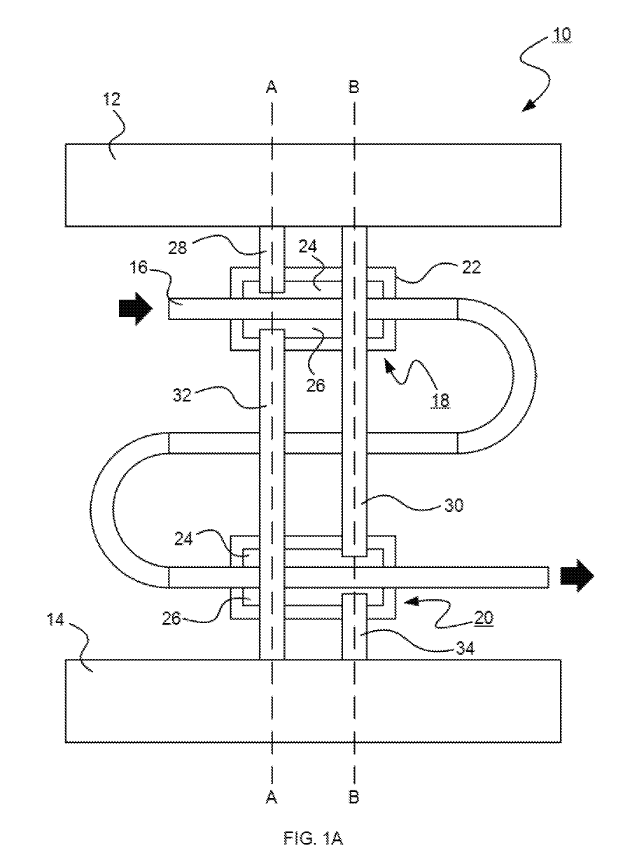

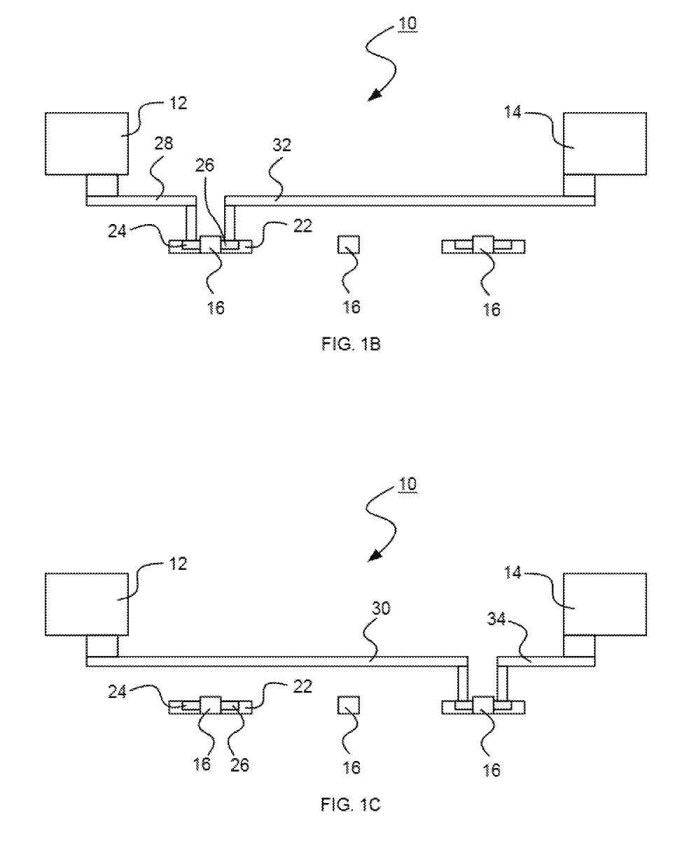

Referring now to FIGS. 1A through 1C, a phase-shifter 10 for optical modulation is shown. The phase-shifter 10 includes a first electrode 12, a second electrode 14, a waveguide 16 in a folded configuration between the first and second electrodes 12 and 14, and PN junctions 18 and 20 provided with the waveguide 16 and connected to the first and second electrodes 12 and 14.

The phase-shifter 10 may be incorporated into an apparatus such that the apparatus includes an optical waveguide modulator with a folded phase-shifter configuration. Advantageously, the folded configuration of the waveguide 16 enhances interaction between electrical signals and the optical mode, thereby improving modulation efficiency of the modulator.

The phase-shifter 10 may be segmented, each segment including a portion of the waveguide 16 and being provided with one of the PN junctions 18 and 20. In the present embodiment, two (2) adjacent phase-shifter segments are arranged in parallel with an output of a preceding phase-shifter segment connected to an input of a following phase-shifter segment via a waveguide with bends. To reduce or minimise degradation of high-speed device characteristics due to a path difference between the light at the inputs of the first and second phase-shifter segments, the path difference may be made sufficiently short such that there is negligible or minimal impact on the high-speed device characteristics.

The first and second electrodes 12 and 14 may be radio frequency (RF) signal electrodes. In the present embodiment, the first and second electrodes 12 and 14 are provided in the form of two (2) parallel metal electrodes in a top metal layer.

The waveguide 16 may be made of an electro-optical material such as, for example, silicon (Si). By applying a dynamic electrical signal to the first and second electrodes 12 and 14, the phase of the light is modulated due to the electro-optical properties of the waveguide material. In the present embodiment, the waveguide 16 may include a combination of channel waveguides (fully etched) and rib waveguides (partially etched). Advantageously, with such a configuration, the foot print of the modulator may be smaller as the minimum bend radius may be smaller.

In the embodiment shown, each of the PN junctions 18 and 20 is embedded in a silicon slab region 22 and includes an n-type region 24 and a p-type region 26.

In the present embodiment, the PN junctions 18 and 20 are connected in parallel to the first and second electrodes 12 and 14. In the embodiment shown, the first electrode 12 is connected to positive terminals of first and second PN junctions 18 and 20 and the second electrode 14 is connected to negative terminals of the first and second PN junctions 18 and 20. More particularly, in the embodiment shown, the first electrode 12 in the top metal layer is connected to the n-type region 24 of a first phase-shifter segment via a first metal interconnect 28 in a second metal layer. The first electrode 12 is also connected to the n-type region 24 of a second phase-shifter segment via a second metal interconnect 30 in the same metal layer. The second electrode 14 in the top metal layer is connected to the p-type region 26 of the first phase-shifter segment via a third metal interconnect 32 in the second metal layer. The second electrode 14 is also connected to the p-type region 26 of the second phase-shifter segment via a fourth metal interconnect 34 in the same metal layer.

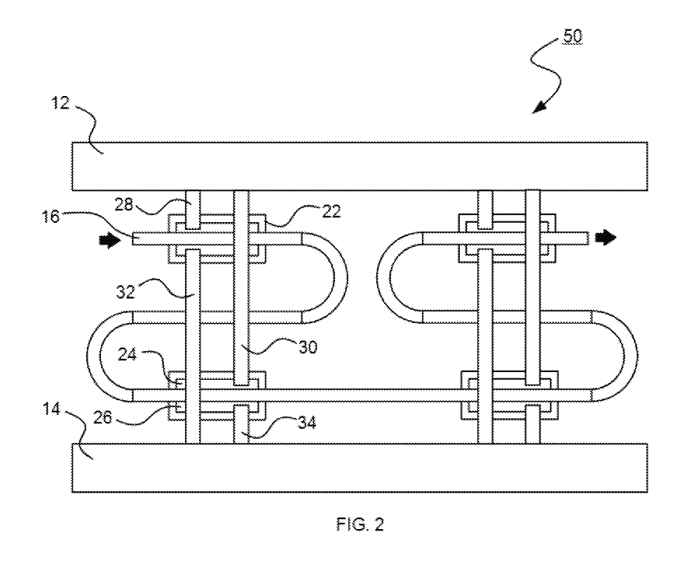

Referring now to FIG. 2, a phase-shifter 50 for optical modulation in accordance with another embodiment of the present invention is shown. The phase-shifter 50 of the present embodiment differs from the previous embodiment in that the folded configuration of the waveguide is repeated or cascaded to increase an overall length of the modulator for sufficient modulation efficiency. In this manner, a modulator with a sufficiently long total length for a given modulation efficiency may be realized.

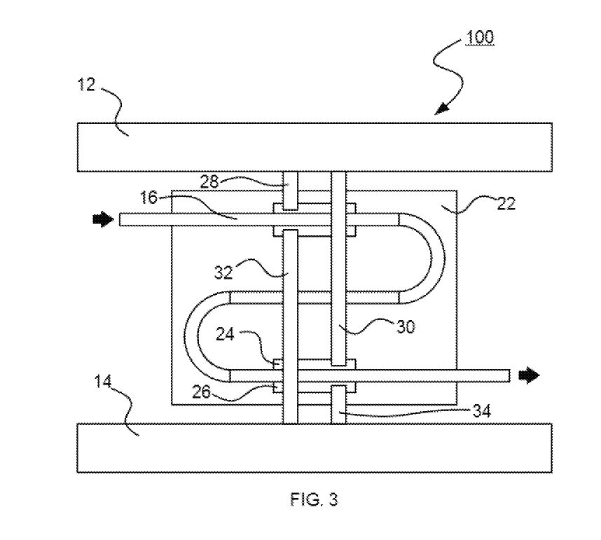

Referring now to FIG. 3, a phase-shifter 100 for optical modulation in accordance with yet another embodiment of the present invention is shown. The phase-shifter 100 of the present embodiment differs from the earlier embodiments in that the folded modulator phase-shifter is realized using only rib waveguides (partially etched).

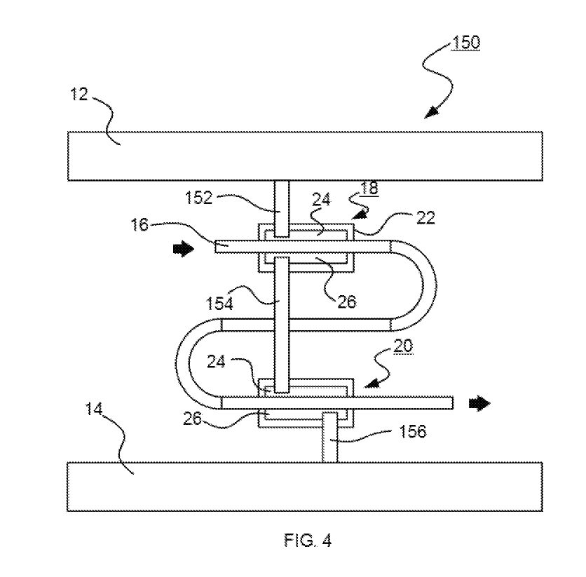

Referring now to FIG. 4, a phase-shifter 150 for optical modulation in accordance with still another embodiment of the present invention is shown. The phase-shifter 150 of the present embodiment differs from the earlier embodiments in that the first and second PN junctions 18 and 20 are connected in series to the first and second electrodes 12 and 14. In the embodiment shown, the first electrode 12 is connected to a positive terminal of a first PN junction 18, the second electrode 14 is connected to a negative terminal of a second PN junction 20 and a negative terminal of the first PN 5 junction 18 is connected to a positive terminal of the second PN junction 20. More particularly, in the embodiment shown, the first electrode 12 is connected to the n-type region 24 of a first phase-shifter segment via a first metal interconnect 152, the p-type region 26 of the first phase-shifter segment is connected to the n-type region 24 of a second phase-shifter segment via a second metal interconnect 154, and the p-type region 26 of the second phase-shifter segment is connected to the second electrode 14 via a third metal interconnect 156.

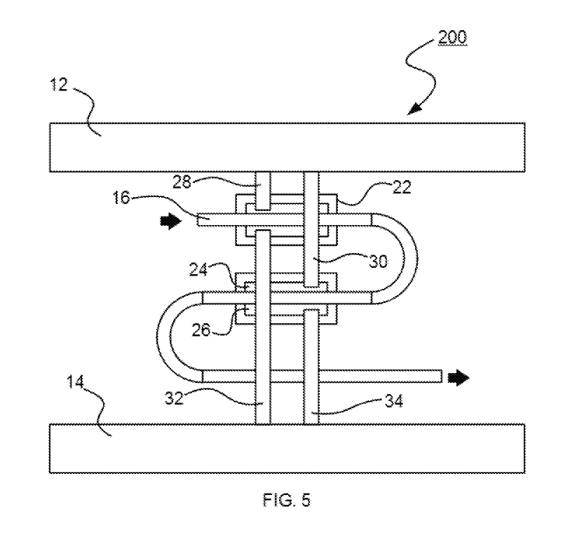

Referring now to FIG. 5, a phase-shifter 200 for optical modulation in accordance with yet another embodiment of the present invention is shown. The phase-shifter 200 of the present embodiment differs from the earlier embodiments in that the second phase-shifter segment is placed after a first bend.

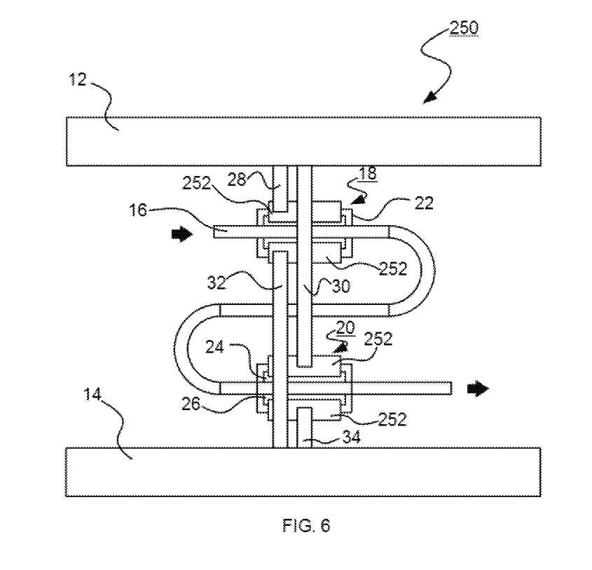

Referring now to FIG. 6, a phase-shifter 250 for optical modulation in accordance with still another embodiment of the present invention is shown. The phase-shifter 250 of the present embodiment differs from the earlier embodiments in that a plurality of third electrodes 252 is provided with the first and second PN junctions 18 and 20. In such an embodiment, the first and second PN junctions 18 and 20 are connected to the first and second electrodes 12 and 14 via the third electrodes 252. In the embodiment shown, the third electrodes 252 may be provided in a second metal layer and may extend along a length of each phase-shifter segment.

As is evident from the foregoing discussion, the present invention provides a phase-shifter with improved performance for high speed modulation due to increased interaction between the electrical radio frequency (RF) signals travelling in the metal electrodes and light travelling in the folded waveguide.

While preferred embodiments of the invention have been illustrated and described, it will be clear that the invention is not limited to the described embodiments only. Numerous modifications, changes, variations, substitutions and equivalents will be apparent to those skilled in the art without departing from the scope of the invention as described in the claims. The phase-shifter of the present invention may be applied to stand-alone phase modulators and single and nested Mach-Zehnder modulators in single-ended or push-pull configurations.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A phase-shifter for optical modulation, comprising:
a first electrode;
a second electrode;
a waveguide in a folded configuration between the first and second electrodes; and
one or more PN junctions provided with the waveguide and connected to the first and second electrodes.

2. The phase-shifter of claim 1, wherein the phase-shifter is segmented, each segment being provided with one of the one or more PN junctions.

3. The phase-shifter of claim 1, wherein the one or more PN junctions comprises a plurality of PN junctions, the PN junctions being connected in parallel to the first and second electrodes.

4. The phase-shifter of claim 3, wherein the first electrode is connected to positive terminals of first and second PN junctions and the second electrode is connected to negative terminals of the first and second PN junctions.

5. The phase-shifter of claim 1, wherein the one or more PN junctions comprises a plurality of PN junctions, the PN junctions being connected in series to the first and second electrodes.

6. The phase-shifter of claim 5, wherein the first electrode is connected to a positive terminal of a first PN junction, the second electrode is connected to a negative terminal of a second PN junction and a negative terminal of the first PN junction is connected to a positive terminal of the second PN junction.

7. The phase-shifter of claim 1, wherein the folded configuration of the waveguide is cascaded.

8. The phase-shifter of claim 1, wherein the waveguide comprises one or more of a rib waveguide and a channel waveguide.

9. The phase-shifter of claim 1, further comprising one or more third electrodes provided with the one or more PN junctions, wherein the one or more PN junctions are connected to the first and second electrodes via the third electrodes.
